(19) United States
(12) Patent Application Publication
(10) Pub. No.: US 2018/0305062 A1
(43) Pub. Date: Oct. 25, 2018

(54) DEVICE AND METHOD FOR LABELING INDIVIDUAL PACKAGES

(71) Applicant: ESPERA-WERKE GmbH, Duisburg (DE)

(72) Inventor: Peter WOLFF, Swisttal-Heimerzheim (DE)

(73) Assignee: ESPERA-WERKE GmbH, Duisburg (DE)

(21) Appl. No.: 15/767,952

(22) PCT Filed: Jul. 20, 2016
(86) PCT No.: PCT/EP2016/067281

§ 371 Date: Apr. 12, 2018

(30) Foreign Application Priority Data
Nov. 6, 2015 (DE) 10 2015 119 153.9

(51) Int. Cl. B65C 9/36; B65C 9/40

(52) U.S. Cl. CPC B65C 9/36; B65C 9/1884; B65C 9/40

(57) ABSTRACT

An apparatus (1) for labelling a package (2) including an advancing device (3), a dispensing device (4), an application device (6) and a control device (7). The application device includes a punch (10) having a punch shank (8) with a second shank end (8b) to which a punch foot (9) for moving a dispensed label (5) from at least one receiving position (A, A′) to at least one delivery position (B) is connected, and a plurality of motors (11, 12, 13, 14) controlled by the control device, each of which is configured to move the punch shank in a direction parallel to one of at least three different directions (X, Y, Z, C). The motors are mounted such that during simultaneous movement of the punch shank by the motors, none of the motors change position relative to another of the motors. A method for labelling a package is also disclosed.

The invention relates to an apparatus for labelling individual packagings with an advancing device for transporting the respective packaging in a transport direction, with a dispensing device for dispensing a label in a dispensing direction, with an application device for applying the dispensed label on the respective packaging, with a control device for controlling the application device, wherein the application device comprises a punch, which comprises a punch shank and a punch foot, for moving the dispensed label from at least one receiving position, in which the label is picked up by the punch foot, to at least one delivery position, in which the label can be applied on the packaging by the punch foot, wherein the punch shank extends in an extension direction from a first shank end to a second shank end, at which the punch foot is connected to the punch shank, wherein the punch shank is mounted in the application device in such a way that it can perform movements parallel to at least three different directions, wherein the application device comprises a plurality of motors controlled by the control device, each of which motors brings about another of the movements.

Furthermore, the invention relates to a method for labelling individual packagings, in particular using an apparatus as defined above, wherein the respective packaging is transported in a transport direction, wherein a label is dispensed in a dispensing direction, wherein the dispensed label is picked up in a receiving position by a punch foot of a punch comprising the punch foot and a punch shank connected thereto and wherein the punch shank with the label picked up by the punch foot is moved by a plurality of motors, until the label is applied on the packaging by the punch foot in a delivery position.

A corresponding apparatus and a corresponding method are known for example from JP 2005-193926 A. In this apparatus, a punch foot is moved linearly (in a translational manner) along three axes orthogonal to one another (axis in the X-direction, axis in the Y-direction, axis in the Z-direction) into a receiving position for receiving a label and from there into a delivery position for applying the label on a packaging. Moreover, the punch foot can be moved together with the punch shank in a rotational manner about an axis of rotation (central axis) of the punch shank, which extends parallel to the Y-direction.

With such an apparatus and such a method, the label can be transported along the three axes, i.e. along the X-direction (X-axis), the Y-direction (Y-axis) and the Z-direction (Z-axis) and rotated about the fourth axis (axis of rotation, C-axis), in order thus to be positioned as accurately as possible on a packaging to be labelled. The movements in the four different directions (three linear movements, one rotational movement) are required when the label is dispensed from the dispensing device into a position (receiving position) which is spaced apart horizontally and vertically from the packaging to be labelled at the time. These spacings are bridged by linear movements. Furthermore, it is often desired to position the label in a specific orientation to the longitudinal edges of the packaging on said packaging, which may possibly make it necessary for the label picked up by the punch foot to be rotated before the application onto the packaging.

It may also be necessary to move the punch foot in a horizontal direction in the plane of the receiving position, so as to be able always to position the punch foot centrally with respect to the label also with different label sizes (in particular label lengths). In said position, the label is then picked up by the punch foot, for example by generating an underpressure in the punch foot, which is then constituted as a suction nozzle. In the state when suction is applied, the label is then moved towards the packaging, where it is applied.

The application can take place in various ways. For example, the punch foot can apply the label by contact on the packaging, whereby the punch foot presses the label onto the packaging. It is however also known to apply a label without contact, whereby the punch foot blows the label off by generating a compressed air blast directed towards the packaging. In the latter case, the punch foot is constituted as a blow-off nozzle.

When labelling packagings, a plurality of steps thus has to be carried out from the time of dispensing a label up to the time of applying the label on the packaging, including the reliable application of suction to the label by the punch foot, the performance of at least one horizontal movement, the performance of a vertical movement, the performance of a rotational movement and the transfer of the label onto the packaging, for example by blowing-off. If appropriate, a further horizontal movement must also be performed to orientate the punch foot with respect to the different label lengths or label receiving positions. All these steps each require a certain amount of time. The respective duration of the individual steps in turn has an effect on the total duration of the labelling process.

It is the problem of the present invention, therefore, to specify an apparatus and a method, with which the labelling of individual packagings can be carried out with the greatest possible speed.

According to a first teaching of the present invention, in the case of an apparatus for labelling individual packagings with an advancing device for transporting the respective packaging in a transport direction, with a dispensing device for dispensing a, in particular printed, label, for example a label detachable from a carrier strip or a linerless label (carrier-less label), in a dispensing direction, with an application device for applying the dispensed label onto the respective packaging, with a control device for controlling the application device, wherein the application device comprises a punch, comprising a punch shank and a punch foot, for moving the dispensed label from at least one receiving position (of the label), in which the label is picked up by the punch foot, to at least one delivery position (of the label), in which the label can be applied by the punch foot onto the packaging, wherein the punch shank extends in an extension direction from a first (upper) shank end to a second (lower) shank end, at which the punch foot is connected to the punch shank, wherein the punch shank is mounted in the application device in such a way that it can perform movements parallel to at least three different, in particular four different, directions, wherein the application device comprises a plurality of motors controlled by the control device, each one whereof brings about another of the movements, the problem derived and outlined above is solved by the fact that the control device is configured such that the punch shank can be moved simultaneously parallel to at least three of the directions, and that the motors, which bring about the simultaneous movement of the punch shank parallel to the at least three directions, are mounted in the application device in such a way that, during a simultaneous movement of the punch shank parallel to the at least three directions, none of these motors changes its position relative to the at least two other of these motors.

The control device thus controls the motors in such a way that at least three of them are operated (actuated or switched on) simultaneously and the individual movements (each motor brings about a specific individual movement) are thus superimposed, as a result of which a simultaneous movement (superimposed respectively resultant movement) of the punch shank is brought about. The punch shank is not therefore first moved in a first direction, after completion of this movement moved in a second direction and finally, once again after completion of this movement, moved in yet another direction or rotated, but rather it performs a continuous single movement along a movement path, wherein this movement path is at least between the at least one receiving position and the delivery position in particular continuous (i.e. in particular, no stopping of the movement and/or no abrupt change of movement occurs). The duration of the transport of a label between the respective receiving position and the delivery position is thus already markedly reduced.

In addition, there is the fact that the motors, which bring about the simultaneous (resultant) movement of the punch shank, are stationary (immovable) relative to one another. In particular, these motors are also stationary inside the application device and/or relative to the advancing or dispensing device. This has the advantage that the motors are not jointly moved during the simultaneous movement of the punch shank brought about by them. Thereby the number of components which perform the simultaneous movement together with the punch shank parallel to the at least three directions, and therefore also the weight of the totality of these moved components, is considerably reduced compared to the prior art. In particular, at least the motor for the rotational movement of the punch shank, the motor for the movement in the extension direction of the punch shank and one of the motors for a movement orthogonal thereto, in particular for the movement parallel to the dispensing direction, is not jointly moved. Due to the fact that said motors are not jointly moved with said simultaneous movement of the punch shank, the movements of the punch shank can be performed much more quickly than in the prior art, which correspondingly applies to the simultaneous movement of the punch shank parallel to the at least three directions. The duration of the transport of a label between the receiving position and the delivery position can thus be further reduced.

At least 180 labelling operations per minute, preferably at least 190 labelling operations per minute, particularly preferably at least 200 labelling operations per minute can be carried out with the apparatus according to the invention for labelling individual packagings and with a corresponding labelling method, since the masses to be moved are reduced to a minimum. The preceding values can be achieved without problem in the case of packagings with a height of 1 mm to 160 mm.

Various embodiments of the apparatus according to the invention, which are also the subject-matter of the sub-claims, are described in detail below.

According to an embodiment, provision is made such that the punch shank is mounted in the application device in such a way that it can perform at least three of the following movements:
a translational (i.e. linear) movement parallel to a first direction (also referred to in the following as the Y-direction) orthogonal to the extension direction,
a translational movement parallel to a second direction (also referred to in the following as the X-direction) orthogonal to the extension direction and to the first direction,
a translational movement parallel to a third direction (also referred to in the following as the Z-direction) parallel to the extension direction,
a rotational movement parallel to a fourth direction (also referred to in the following as the C-direction) about an axis of rotation (central axis) of the punch shank, which axis of rotation extends parallel to the extension direction.

In the sense of the inventions, movements “parallel” to a direction are understood to mean that the punch shank can be or is moved in the and/or opposite to the respective direction. The fourth direction is a circumferential direction, i.e. a movement parallel thereto is a movement along a parallel curve of the circumferential direction. The punch shank simultaneously performs, as stated, at least three of the previously defined movements, but can preferably also perform all four of these movements simultaneously. In the latter case too, when four movements are performed simultaneously, it is conceivable that none of the motors required for this is jointly moved.

The individual motors are defined below. According to a further embodiment, provision is thus made such that
a first of the motors brings about a translational movement parallel to a first direction (Y-direction) orthogonal to the extension direction and/or
a second of the motors brings about a translational movement parallel to a second direction (X-direction) orthogonal to the extension direction and to the first direction and/or
a third of the motors brings about a translational movement parallel to a third direction (Z-direction) parallel to the extension direction and/or
a fourth of the motors brings about a rotational movement parallel to a fourth direction (C-direction) about an axis of rotation which extends parallel to the extension direction.

The first of the motors is configured in particular to bring about a translational movement at an angle, preferably orthogonal, to the dispensing direction and in particular also at an angle respectively orthogonal to the transport direction. The second of the motors is configured in particular to bring about a translational movement parallel to the dispensing direction and in particular also parallel to the transport direction. The third of the motors is configured in particular to carry out a translational movement at an angle, preferably orthogonal, to the dispensing direction. The fourth of the motors is configured in particular to bring about a rotational movement about an axis of rotation, which extends at an angle, preferably orthogonal, to the dispensing direction.

According to a further embodiment, provision is made such that the control device is configured such that it can simultaneously actuate at least the second motor, the third motor and the fourth motor and in particular can simultaneously actuate the first motor, the second motor, the third motor and the fourth motor.

According to a further embodiment, provision is made such that the dispensing direction runs parallel to the transport direction, wherein the dispensing direction and the transport direction preferably lie in parallel planes and/or run orthogonal to the direction of gravity. Alternatively, it is also conceivable that the dispensing direction runs orthogonal to the transport direction, wherein the dispensing direction and the transport direction then preferably also lie in parallel planes and/or orthogonal to the direction of gravity. Furthermore, it is conceivable that the first and the second direction run orthogonal to the direction of gravity and/or the third direction runs parallel to the direction of gravity and/or the fourth direction runs in a plane orthogonal to the direction of gravity.

According to a further embodiment of the apparatus according to the invention, provision is made such that the application device comprises a punch carrier, in or on which the punch shank is mounted movably parallel to the third direction and/or fourth direction. The punch carrier is in particular a housing, in which the punch shank is mounted movably. In particular, the punch carrier does not comprise a separate guide tube for the punch shank, in order to further minimise the weight of all the moving components.

According to a further embodiment, provision is made such that the application device comprises a punch shank holder, which is mounted movably parallel to the third direction in or on the punch carrier and to which the punch shank is connected immovably.

According to a further embodiment, provision is made such that the application device comprises a guide device, in or on which the punch carrier and/or a guided device forming a component of the punch carrier, in particular a sled forming a component of the punch carrier, is mounted movably parallel to a direction from a group comprising the first direction and the second direction, preferably parallel to the second direction (X-direction). The guided device respectively the sled is in particular connected immovably (stationary) to the rest of the punch carrier.

According to a further embodiment, provision is made such that the application device comprises a frame, in or on which the guide device is mounted movably parallel to another direction from the group comprising the first direction and the second direction, preferably parallel to the first direction (Y-direction). Such a frame is arranged in particular stationary in a labelling apparatus and preferably also supports the advancing device and/or the dispensing device and/or the control device.

According to a further embodiment, provision is made such that at least one, preferably at least two, particularly preferably at least three of the motors, in particular the motors bringing about the simultaneous movement of the punch shank parallel to the at least three directions, is/are stationary relative to the guide device or the frame and is/are in particular connected to the guide device or the frame.

According to a further embodiment, provision is made such that at least the first motor is stationary relative to the frame and in particular is connected to the frame.

According to a further embodiment, provision is made such that the first motor, the second motor, the third motor and/or the fourth motor or the component movable in each case by the motor comprises a position sensor. The components movable in each case by the motor are selected from a group comprising amongst others the punch carrier, the punch shank, the punch shank holder and the guide device. Both the first motor and the second motor thus in each case moves, for example, at least the punch carrier and the punch shank, wherein one of the two motors can also move the guide device. The third motor moves at least the punch shank holder and the punch shank. The fourth motor moves at least the punch shank. An exact calibration of the application device can on the one hand be carried out with a corresponding position sensor on the motor or on one of the respective movable components. On the other hand, the position sensor also permits a reproducible approach of the individual positions (one of the receiving positions and the delivery position) of the label with a high degree of accuracy.

In particular, the respective motor is a position-controlled motor, in particular a stepping motor. Such a motor also has the advantage that a label can be applied contactless on a packaging, in that the motor stops shortly before the surface which is to be provided with the label and then blows the label off in the direction of the surface.

According to a further embodiment, provision is made such that the first motor, the second motor, the third motor and/or the fourth motor is connected via a gear unit to the component movable in each case by the motor (in particular punch carrier, punch shank, punch shank holder and/or guide device). In particular, the gear unit comprises, as will be explained in greater detail below, at least two wheels cooperating as gear partners, in particular toothed wheels. The wheels can be connected to one another with a belt, in particular a toothed belt, or by cable pull or belt pull. A direct connection between two wheels is also conceivable. Alternatively or in addition, the gear unit can also comprise at least one spindle with at least one spindle nut movable thereon, wherein the spindle and the spindle nut each represent gear partners. For safety-related reasons, a coupling can also be provided between two gear partners, respectively, which coupling responds in the event of an overload. Moreover, one or more of the axles driven respectively by the first motor, the second motor, the third motor and/or the fourth motor can be provided with a brake, which can be actuated so as to be active in order to actively damp vibrations.

The first motor, i.e. the one which brings about the movement or sub-movement of the superimposed movement parallel to the X-direction and in particular parallel to the transport direction, is preferably provided with a gear unit, which comprises a spindle with a spindle nut as gear partners. Alternatively, a gear unit can also be provided which comprises wheels, in particular toothed wheels, and a belt, in particular a toothed belt. The second motor, i.e. the one which brings about the movement or sub-movement of the superimposed movement in the transverse direction and in particular transversely to the transport direction, is preferably connected to a gear unit which comprises wheels, in particular toothed wheels, and a belt, in particular a toothed belt. Alternatively, the use of a spindle with a spindle nut is also conceivable here. The third motor for the movement in the Z-direction, i.e. along the extension direction of the punch shank, is also preferably connected to a gear unit which comprises wheels, in particular toothed wheels, and a belt, in particular a toothed belt. Alternatively, it is also conceivable to use a cable pull or belt pull for this movement or corresponding sub-movement of the superimposed movement. For the rotational movement of the punch shank, the fourth motor bringing about this movement is also preferably connected to a gear unit which comprises wheels, in particular toothed wheels and a belt, in particular a toothed belt.

Special gear unit variants are described in greater detail below for the individual applications.

According to an embodiment, provision is thus made such that the third motor drives a first drive wheel, in particular a toothed wheel, via which a first endless belt is guided, wherein the first endless belt is also guided via at least five, preferably exactly five, or via at least eleven, preferably exactly eleven, deflection rollers. It is conceivable here that the first drive wheel and at least one, preferably exactly one, or at least four, preferably exactly four, of the deflection rollers are stationary relative to the third motor and/or at least four, preferably exactly four, or at least seven, preferably exactly seven, of the deflection rollers are stationary relative to the punch carrier and in particular are connected to the punch carrier. Such a variant of a gear unit is advantageous especially for the movement or sub-movement of the superimposed movement parallel to the extension direction of the punch shank.

In particular, provision is made such that a first portion (extending between two deflection rollers) of the first endless belt runs parallel to the third direction, wherein the first portion is stationary with respect to the punch shank or punch shank holder and is connected thereto, wherein the first portion extends in particular between two of the deflection rollers which are fastened to the punch carrier. Provision can also be made such that at least four, preferably exactly four, or at least ten, preferably exactly ten, further portions (in each case extending between two deflection rollers or between a deflection roller and the first drive wheel) of the first endless belt run at an angle, in particular orthogonal, to the third direction and preferably parallel to the second direction and/or at an angle, in particular orthogonal, to the first direction, wherein the further portions in particular do not make mutual contact.

It is also conceivable that, of the further portions:
no portion or at least one portion or at least two portions extends/extend between the first drive wheel and one of the deflection rollers stationary relative to the first drive wheel and/or
at least one portion or at least four portions or at least six portions respectively extends/extend between one of the deflection rollers stationary relative to the first drive wheel and one of the deflection rollers fastened to the punch carrier and/or
no portion or at least two portions respectively extends/extend between two of the deflection rollers fastened to the punch carrier and/or
no portion or at least one portion or at least two portions extends between the first drive wheel and one of the deflection rollers fastened to the punch carrier.

The preceding combination, comprising a first portion, which runs parallel to the third direction and therefore also to the extension direction of the punch shank, and further portions between wheels (deflection rollers, drive wheels), which in part are stationary relative to the motor and/or the first drive wheel and in part are stationary relative the punch carrier and are in particular fastened thereto, makes it possible to move the punch carrier independently of the third motor, so that, during the movement of the punch carrier, the motor does not have to be carried along with the latter.

According to a further embodiment, provision is made such that the punch shank in or on the punch carrier is guided in at least one, preferably at least two, particularly preferably at least three bearing(s), in particular sliding bearing(s), ball bearing(s) or roller bearing(s), which is/are stationary relative to the punch carrier and are in particular connected to the punch carrier. The punch shank is preferably not mounted in its own guide tube, which provides a weight saving.

According to a further embodiment, provision is made such that the punch shank holder, in particular in a portion between two of the bearings, is movable relative to the punch carrier parallel to the third direction by a distance in a range from 100 to 200 mm, preferably 120 to 180 mm, particularly preferably 140 to 160 mm.

According to a further embodiment, provision is made such that a punch shank drive wheel is connected non-rotatably to the punch shank and is movable (rotatable) together with the punch shank parallel to the fourth direction, wherein the punch shank drive wheel is stationary relative to the punch carrier and is in particular connected to the punch carrier. The punch shank drive wheel is arranged in particular coaxial with respect to the bearing or bearings and/or between two of the bearings.

In the case of a gear unit variant, provision is made such that the fourth motor drives a second drive wheel, in particular a toothed wheel, via which a second endless belt is guided, wherein the second endless belt is also guided via at least two deflection rollers and the punch shank drive wheel. It is conceivable that the second drive wheel and at least one of the deflection rollers are stationary relative to the fourth motor and/or at least one of the deflection rollers is/are stationary relative to the punch carrier and is/are in particular connected to the punch carrier.

Provision is preferably made such that a first portion (extending between the second drive wheel and the punch shank drive wheel) and in particular at least one, preferably at least two, particularly preferably at least three further portion(s) (extending in each case between two deflection rollers or between the second drive wheel and a deflection roller or between the punch shank drive wheel and a deflection roller) of the second endless belt run at an angle, in particular orthogonal, to the third direction and preferably parallel to the second direction and/or at an angle, in particular orthogonal, to the first direction, wherein the portions in particular do not make mutual contact. Particularly preferably, provision is made such that a first portion of the second endless belt, which extends between the punch shank drive wheel and the second drive wheel, and at least one portion, which extends between a deflection roller stationary relative to the motor and a deflection roller stationary relative to the punch carrier, run at an angle, in particular orthogonal, to the third direction and preferably parallel to the second direction and/or at an angle, in particular orthogonal, to the first direction, wherein the at least two portions in particular run parallel to one another.

By providing a gear unit as previously defined for the rotational movement, the punch carrier can be moved relative to the fourth motor for the rotational movement. This motor likewise does not therefore have to be fastened to the punch carrier and carried along by the latter.

According to a further embodiment, provision is made such that the punch shank (and therefore the punch foot) is movable (rotatable) relative to the fourth motor parallel to the fourth direction through at least 90°, preferably through at least 180°, particularly preferably through at least 360°, in particular in steps in a range from 0.5 to 2°, preferably 0.5 to 1.5°, particularly preferably 1°.

According to a further embodiment, provision is made such that the punch carrier is movable relative to the third motor and/or fourth motor parallel to the second direction by a distance in a range from 30 to 60 mm, preferably 35 to 50 mm, particularly preferably 40 to 45 mm. Accordingly, the deflection roller(s) fastened to the punch carrier is/are also movable parallel to the second direction, by the corresponding distance in the stated ranges, relative to the deflection roller(s) which are stationary relative to the third and/or fourth motor.

For the sake of completeness, it should be mentioned that the first motor and/or the second motor can also be provided with a gear unit, wherein the respective motor drives a drive wheel, in particular a toothed wheel, via which an endless belt is guided, wherein the endless belt can also be guided via one or more deflection rollers. The respective drive wheel is stationary relative to the motor which drives the latter. Deflection rollers can for example be fastened to the punch carrier. Alternatively, it is also conceivable that the respective motor drives a spindle, wherein the spindle nut can be fastened to the punch carrier.

Finally, reference should also be made to particular possible embodiments of the punch and in particular the punch foot, which are particularly advantageous for the apparatus according to the invention and the method yet to be described below.

According to an embodiment, provision is thus made such that the punch foot is constituted as a blow-off and/or suction nozzle and the punch shank and/or punch foot is connected to a compressed air connection, to which an underpressure and/or an overpressure can be applied.

It is preferable if the compressed air connection is connected to the first (upper) shank end and comprises a supply coaxial with the punch shank, wherein the punch shank is constituted as a hollow shaft, in such a way that there is a fluid connection between the coaxial supply and the punch foot via the punch shank. Alternatively, however, it is also conceivable that the compressed air connection is arranged between the punch shank and the punch foot and comprises a lateral supply (running at an angle to the extension direction of the punch shank), in such a way that there is a fluid connection between the lateral supply and the punch foot. The compressed air connection and in particular the supply preferably cannot be moved by the fourth motor.

According to a second teaching of the present invention with a method for labelling individual packagings, in particular using an apparatus as defined above,
wherein the respective packaging is transported in a transport direction,
wherein a label is dispensed in a dispensing direction,
wherein the dispensed label is picked up in a receiving position by a punch foot of a punch comprising the punch foot and a punch shank connected thereto and
wherein the punch shank with the label picked up by the punch foot is moved by a plurality of motors, until the label is applied by the punch foot on the packaging in a delivery position,
   the problem derived and outlined above is further solved by the fact
that the punch shank, in order to move the label from the receiving position to the delivery position, is moved simultaneously parallel to at least three directions by means of at least three of the motors and
that the motors, which bring about the simultaneous movement of the punch shank parallel to the at least three directions, do not change their position relative to one another during the performance of the simultaneous movement of the punch shank parallel to the at least three directions.

In the method according to the invention, provision is in particular made such that at least three of the following motors are simultaneously actuated to perform the simultaneous movement of the punch shank parallel to the at least three directions:
a first of the motors, which brings about a translational movement parallel to a first direction (Y-direction) orthogonal to the extension direction,
a second of the motors, which brings about a translational movement parallel to a second direction (X-direction) orthogonal to the extension direction and to the first direction,
a third of the motors, which brings about a translational movement parallel to a third direction (Z-direction) parallel to the extension direction,
a fourth of the motors, which brings about a rotational movement parallel to a fourth direction (C-direction) about an axis of rotation, which extends parallel to the extension direction.

There is a multiplicity of possible ways of embodying and developing the apparatus according to the invention and the method according to the invention. In this regard, reference should be made on the one hand to the claims subordinate to independent claims 1 and 33, and on the other hand to the description of examples of embodiment in connection with the drawing. In the drawing:

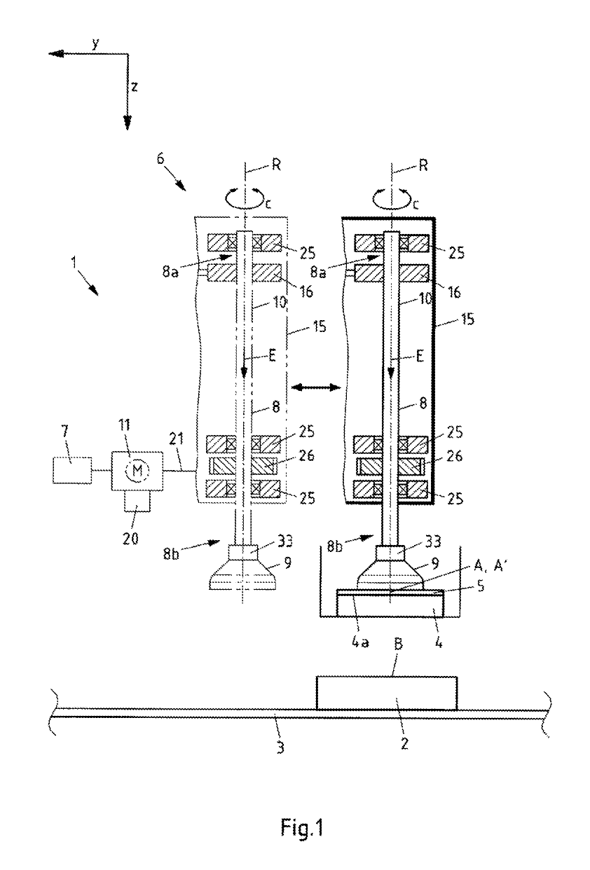

FIG. 1 shows a view of an apparatus according to the invention for labelling individual packagings,

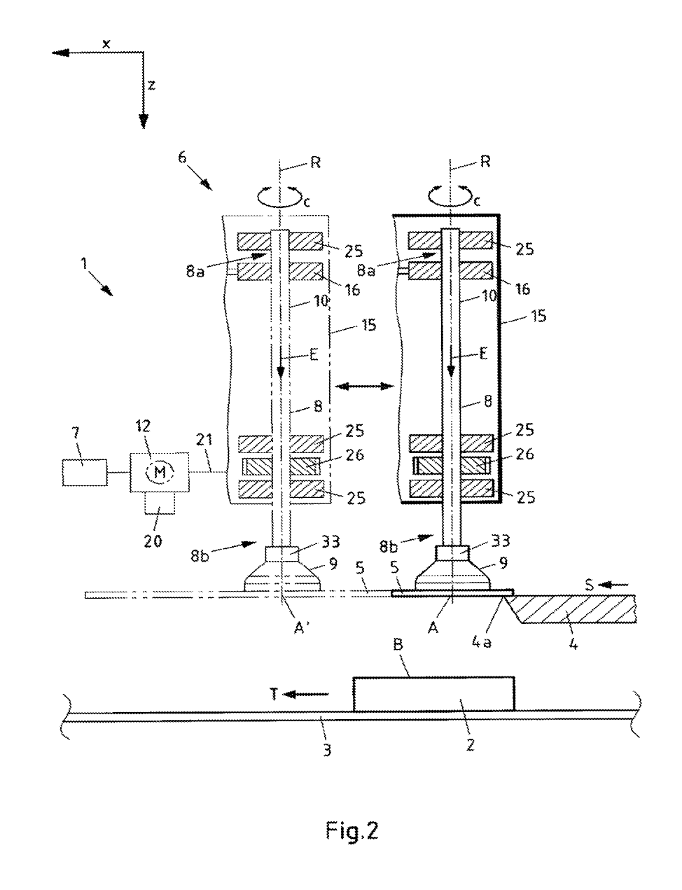

FIG. 2 shows the apparatus from FIG. 1 in a view rotated through 90°,

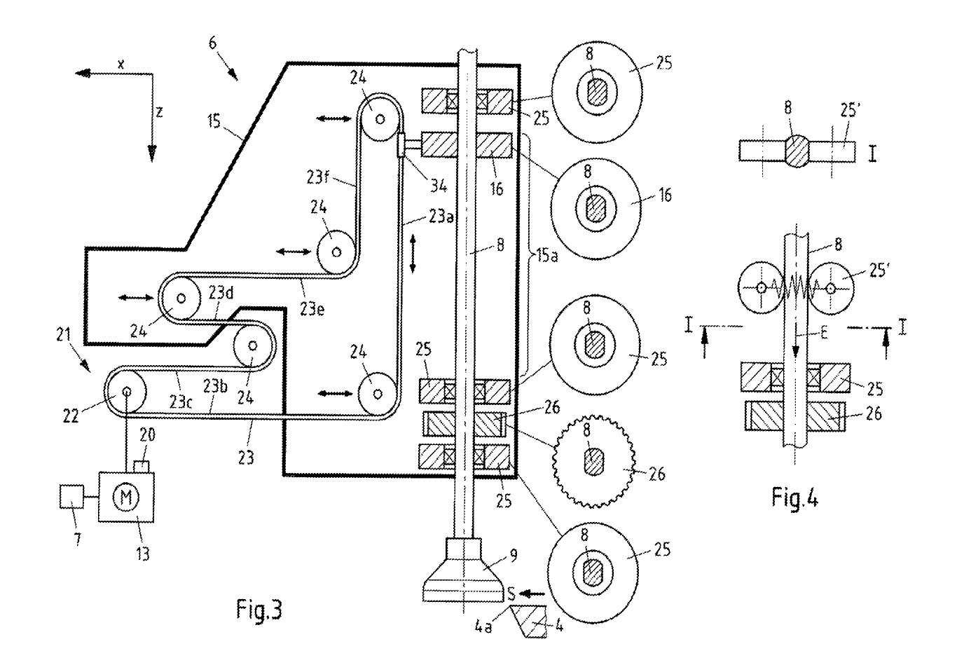

FIG. 3 shows an example of embodiment of an application device of the apparatus from FIGS. 1 and 2,

FIG. 4 shows views of a detail of a further example of embodiment of an application device of the apparatus from FIGS. 1 and 2,

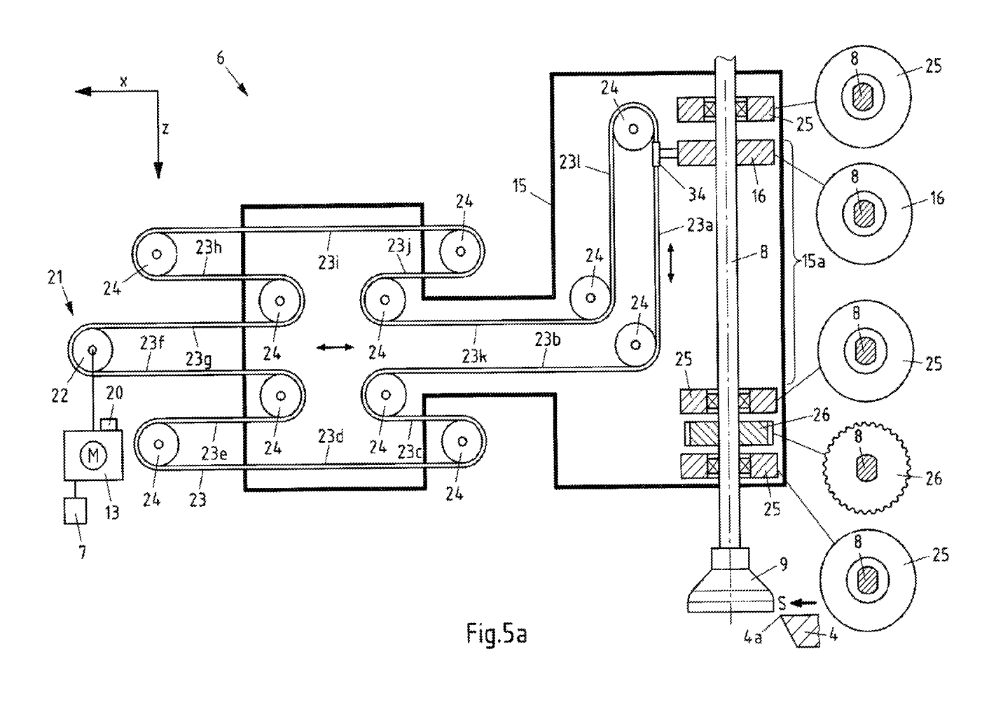

FIG. 5a shows a further example of embodiment of an application device of the apparatus from FIGS. 1 and 2,

FIG. 5b shows a further example of embodiment of an application device of the apparatus from FIGS. 1 and 2,

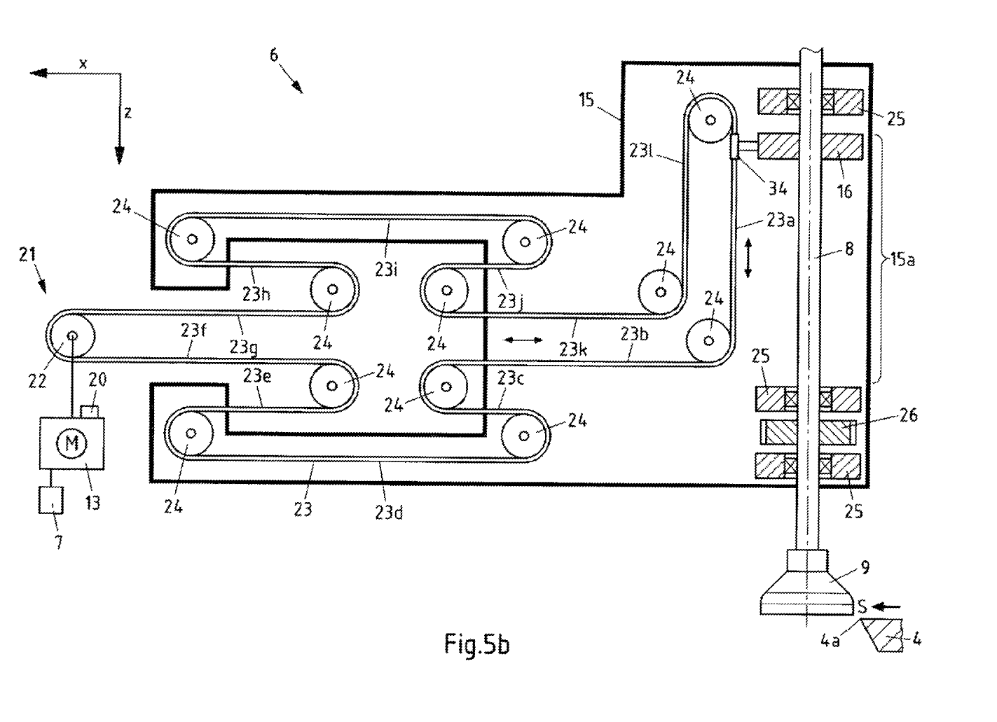

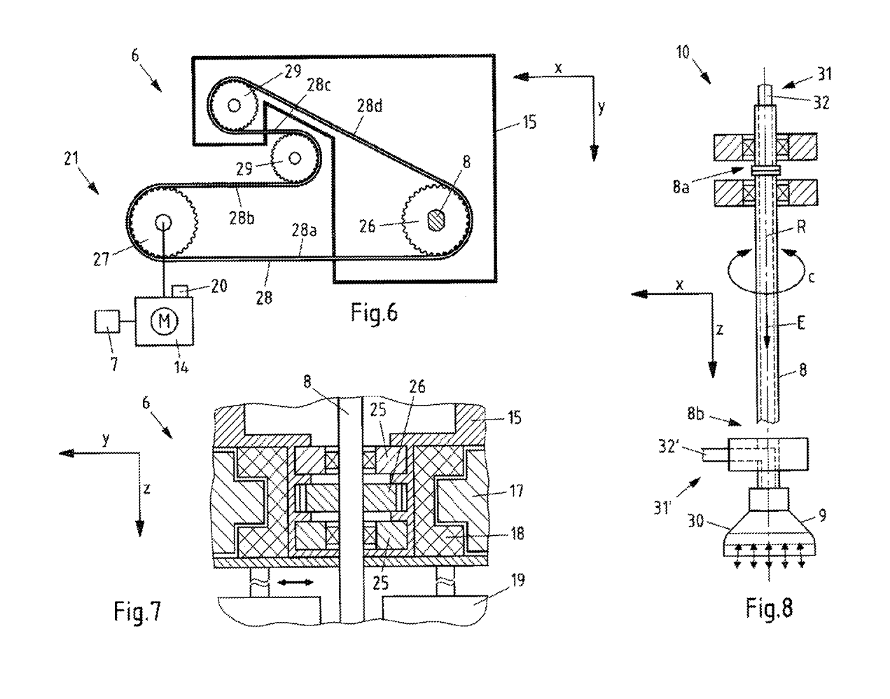

FIG. 6 shows a view of a further detail of an application device,

FIG. 7 shows a view of a further detail of an application device and

FIG. 8 shows views of two examples of embodiment of a punch, comprising a compressed air connection, of an apparatus from FIGS. 1 and 2.

FIGS. 1 to 8 show various views and details of an apparatus 1 for labelling individual packagings 2. It should be pointed out that the figures are purely diagrammatic representations, which are intended to illustrate the individual functions of apparatus 1 only in principle.

As FIGS. 1 and 2 show, apparatus 1 according to the invention is provided
with an advancing device 3 for the transport of respective packaging 2 in a transport direction T,
with a dispensing device 4 for dispensing a label 5 in a dispensing direction S parallel to transport direction T,
with an application device 6 for applying dispensed label 5 on respective packaging 2 and
with a control device 7 for controlling application device 6.

The advancing device is for example a belt conveyor or roller conveyor, on which individual packagings 2 can be successively conveyed through in shown transport direction T vertically beneath application device 6. Application device 6 comprises a punch 10 with a punch shank 8 and a punch foot 9, with which a label 5, which is dispensed by dispensing device 4 and if appropriate is previously printed, is transported from a first receiving position A or second receiving position A′, in which label 5 is picked up by punch foot 9 and is in particular engaged by the latter using suction, to a delivery position B, in which label 5 is applied and in particular blown off by punch foot 9 onto the packaging.

The different receiving positions A and A′ are determined by the given label size. For example, it is advantageous if a label 5 is always picked up centrally by punch foot 9, wherein depending on the label size, in particular the label length, the centre-point of label 5 may be at a different distance from dispensing edge 4a of dispensing device 4. For example, a label 5 may have a format of 37×37 mm, but also a format of 110×110 mm. The respective centre-point of the label is then preferably at a distance of 18.5 mm from dispensing edge 4a in the case of the smaller label and at a distance of 57.5 mm in the case of the larger label. For the sake of completeness, it should be pointed out that two receiving positions A and A′ are described and represented here merely by way of example, but in principle more receiving positions could also be defined depending on the number of different label sizes.

Punch shank 8 extends in an extension direction E from a first, upper shank end 8a to a second, lower shank end 8b, at which punch foot 9 is connected to punch shank 8, for example by means of a quick-action clamp 33. Punch shank 8 is mounted movably in application device 6, and more precisely such that it can perform movements parallel to, here for example, four different directions X, Y, Z and C. Directions X, Y and Z are (linear) directions orthogonal to one another, i.e. each direction runs in each case along a straight line perpendicular to the two other directions. Direction C, on the other hand, is a circumferential direction about a straight axis, i.e. axis of rotation R (central axis) of punch shank 8. Axis of rotation R runs parallel to the Z-direction, which in the represented example of embodiment corresponds to the direction of gravity. The X-direction runs in turn parallel to transport direction T of individual packagings 2 and dispensing direction S of individual labels 5. The Y-direction runs orthogonal to the X-direction and orthogonal to transport direction T and dispensing direction S.

Each of the movements in and opposite to the X-direction, Y-direction, Z-direction and C-direction is brought about by a separate motor of the application device. Each of the motors can perform only one of the movements and none of the remaining movements. Provision is thus made such that
a first of the motors 11 brings about a translational movement parallel to a first direction Y orthogonal to extension direction E and
a second of the motors 12 brings about a translational movement parallel to a second direction X orthogonal to extension direction E and to first direction Y and
a third of the motors 13 brings about a translational movement parallel to a third direction Z parallel to extension direction E and
a fourth of the motors 14 brings about a rotational movement parallel to a fourth direction C about an axis of rotation R, which extends parallel to extension direction E.

Control device 7 controls application device 6, in that it actuates individual motors 11, 12, 13 and 14. Control device 7 is thus capable of simultaneously moving punch shank 8 parallel to at least three of directions X, Y, Z and C by the actuation (switching-on) of three of motors 11, 12, 13 and 14. Punch shank 8 thus performs a superimposed respectively resultant movement, which runs between receiving position A or A′ and delivery position B on a continuous movement path.

Provision is made such that those of motors 11, 12, 13, 14, which bring about the simultaneous movement of punch shank 8 parallel to the at least three directions X, Y, Z, C, i.e. for example motors 12, 13 and 14 for the movement in the Y-, Z- and C-direction, are mounted in application device 6 in such a way that, when a simultaneous movement of punch shank 8 parallel to the three directions Y, Z and C takes place, none of motors 12, 13 and 14 changes its position relative to the respectively two other of these motors 12, 13 and 14. In other words, three motors, i.e. those responsible for the simultaneous (resultant) movement, in particular motors 12, 13 and 14, are always stationary (immovable) relative to one another. Thus, although punch shank 8 moves in the Z-direction and in the C-direction and punch carrier 15 of application device 6 in the X-direction, motors 12, 13 and 14 bringing about these movements are thus not jointly moved.

Punch shank 8 is connected in punch carrier 15, as shown for example in FIG. 3, via a linkage point 34 to a punch shank holder 16, which is mounted movably parallel to the Z-direction in punch carrier 15 and is fixedly connected to punch shank 8. Punch shank holder 16 sits in particular in a press-fit seat on punch shank 8 and thus transmits stroke movements relative to punch carrier 15 (in the Z-direction) by for example up to 160 mm to punch shank 8.

As is further represented diagrammatically in FIG. 7, application device 6 further comprises a guide device 17, in respectively on which punch carrier 15 can be moved via a guided device 18 in the form of a sled parallel to the X-direction respectively transport direction T and dispensing direction S. The maximum travel path in the X-direction is in particular in a range from 20 to 60 mm, preferably in a range from 30 to 50 mm and amounts particularly preferably to 40 mm.

Guide device 17 is in turn mounted on a frame 19 of application device 6, in such a way that it can be moved in the Y-direction and orthogonal to transport direction T and dispensing direction S. The maximum travel path in the Y-direction is in particular in a range from 20 to 250 mm and preferably in a range from 30 to 80 mm.

As already mentioned, punch shank 8 and therefore also punch foot 9 can be moved about axis of rotation R of punch shank 8 parallel to the C-direction. The maximum travel path, i.e. the maximum rotation, amounts here to 360°, wherein the punch shank can be rotated by motor 14 in 1° steps.

In order to increase accuracy during the approach of the individual positions, motors 11 to 14 are each provided with a position sensor 20. Individual motors or all the motors here are by way of example stepping motors.

Motors 11 to 14 are each coupled via a gear unit 21 to the respective component which the respective motor moves. Respective gear unit 21 is represented merely symbolically in FIGS. 1 and 2 as a straight connecting line between respective motor 11 or 12 and application device 6. Gear unit 21, however, can in particular comprise a drive wheel and wheels driven by the latter and/or an endless belt connecting the wheels and optionally deflection rollers (not represented).

Various possible options are described below with the aid of FIGS. 3 to 5b, which ensure that punch shank 8 can be moved up and down in punch carrier 15 parallel to the Z-direction, and also that, independently thereof, punch carrier 15 is movable relative to third motor 13 parallel to the X-direction. For this purpose, punch shank 8 is connected to first endless belt 23 via said punch shank holder 16 and linkage point 34. First endless belt 23 is guided via a first drive wheel 22 connected to third motor 13 as well as a plurality of deflection rollers.

In particular, drive wheel 22 is mounted non-rotatably on a long drive shaft (not represented) running in the Y-direction, which is driven by motor 13. Provision can be made such that drive wheel 22 is displaceable on its drive shaft parallel to the Y-direction when punch carrier 15 is movable parallel to the Y-direction, but motor 13 is not jointly moved. The same also applies in particular to deflection rollers 24 which are arranged stationary with respect to drive wheel 22. For the sake of completeness, it should be mentioned that a drive wheel (not represented) correspondingly driven by second motor 12 can be mounted non-rotatably on a long drive shaft (not represented) running in the Y-direction, which is driven by motor 12, wherein, in this case too, provision can be made such that the drive wheel is displaceable on its drive shaft parallel to the Y-direction when punch carrier 15 is movable parallel to the Y-direction, but motor 12 is not jointly moved.

In the example of embodiment in FIG. 3, five deflection rollers 24 are provided by way of example, whereof four are fastened rotatably to punch carrier 15 (deflection rollers 24 inside the outline representing punch carrier 15 diagrammatically) and one is not connected to punch carrier 15 (deflection roller 24 outside the outline representing punch carrier 15 diagrammatically). The latter is arranged stationary relative to first drive wheel 22 and relative to third motor 13.

In the examples of embodiment in FIGS. 5a and 5b, eleven deflection rollers 24 are provided by way of example, whereof seven are fastened rotatably to punch carrier 15 (deflection rollers inside the outline representing punch carrier 15 diagrammatically) and four are not connected to punch carrier 15 (deflection rollers 24 outside the outline representing punch carrier 15 diagrammatically). The latter are arranged stationary here relative to first drive wheel 22 and relative to third motor 13.

First endless belt 23, which can be a toothed belt, is guided via deflection rollers 24 in such a way that a first portion 23a of first endless belt 23 extending between two deflection rollers 24 runs parallel to the Z-direction, wherein first portion 23a is stationary with respect to punch shank 8.

In the example of embodiment in FIG. 3, five further portions of first endless belt 23 are provided, i.e. a portion 23b between first drive wheel 22 and a deflection roller 24 fastened to punch carrier 15, also a portion 23c between first drive wheel 22 and a deflection roller 24 stationary relative to first drive wheel 22, also a portion 23d between deflection roller 24 stationary relative to first drive wheel 22 and a deflection roller 24 fastened to punch carrier 15 and finally two portions 23e and 23f, running orthogonal to one another, between in each case two of deflection rollers 24 fastened to punch carrier 15.

In the example of embodiment in FIG. 3, first endless belt 23 extends in the clockwise direction starting with first portion 23a with linkage point 34 respectively with punch shank holder 16, in the further course over portion 23b, in the further course then over portion 23c, in the further course then over portion 23d, in the further course then over portion 23e and in the further course then over portion 23f, which finally is again followed by portion 23a.

In the example of embodiment in FIG. 5a, eleven further portions 23b to 23l of first endless belt 23 are also arranged in the clockwise direction in sequence after portion 23a, wherein portions 23b, 23k and 23l each extend between two deflection rollers 24 fastened to the punch carrier, wherein portions 23c, 23e, 23h and 23j each extend between one of deflection rollers 24 fastened to the punch carrier and one of deflection rollers 24 stationary with respect to first drive wheel 22, wherein portions 23d and 23i each extend between two of deflection rollers 24 stationary with respect to first drive wheel 22 and wherein portions 23f and 23g each extend between one of deflection rollers 24 fastened to punch carrier 15 and first drive wheel 22.

In the example of embodiment in FIG. 5a, first endless belt 23 extends in the clockwise direction starting with first portion 23a with linkage point 34 respectively with punch shank holder 16, in the further course over portion 23b, in the further course then over portion 23c, in the further course then over portion 23d, in the further course then over portion 23e, in the further course then over portion 23f, in the further course then over portion 23g, in the further course then over portion 23h, in the further course then over portion 23i, in the further course then over portion 23j, in the further course then over portion 23k and in the further course then over portion 23l, which finally is again followed by portion 23a.

In the example of embodiment in FIG. 5b, eleven further portions 23b to 23l of first endless belt 23 are also arranged in the clockwise direction in sequence after portion 23a, wherein portions 23d, 23i and 23l each extend between two of deflection rollers 24 fastened to the punch carrier, wherein portions 23b, 23c, 23e, 23h, 23j and 23k each extend between one of deflection rollers 24 fastened to the punch carrier and one of deflection rollers 24 stationary with respect to first drive wheel 22 and wherein portions 23f and 23g each extend between one of deflection rollers 24 stationary with respect to first drive wheel 22 and first drive wheel 22.

Likewise in the example of embodiment in FIG. 5a, first endless belt 23 extends in the clockwise direction starting with first portion 23a with linkage point 34 respectively with punch shank holder 16, in the further course over portion 23b, in the further course then over portion 23c, in the further course then over portion 23d, in the further course then over portion 23e, in the further course then over portion 23f, in the further course then over portion 23g, in the further course then over portion 23h, in the further course then over portion 23i, in the further course then over portion 23j, in the further course then over portion 23k and in the further course then over portion 23l, which finally is again followed by portion 23a.

Portions 23b to 23e in FIG. 3 and portions 23b to 23k in FIGS. 5a and 5b run parallel to one another and parallel to the X-direction. Portions 23a and 23f in FIG. 3 and portions 23a and 23l in FIGS. 5a and 5b run parallel to one another, but run orthogonal to the remaining portions respectively parallel to the Z-direction.

If punch carrier 15 is moved back and forth in the X-direction by second motor 12 relative to first drive wheel 22 and third motor 13, first endless belt 23 always remains tensioned. In addition or alternatively to one of deflection rollers 24, a tensioning wheel (not represented) can nonetheless also be provided, which always acts on first endless belt 23 with a pretension. In principle, it is also conceivable, for the movement in the X-direction, additionally or alternatively to actuate third motor 13, wherein at least one of deflection rollers 24 fastened to punch carrier 15 would then have to be retarded simultaneously. It is also conceivable to block third motor 13, i.e. to prevent joint rotation.

Since, in the example of embodiment in FIG. 3, linkage point 34 or punch shank holder 16 is jointly moved during a relative movement of punch carrier 15 in the X-direction relative to first drive wheel 22 and third motor 13, it is necessary here for motor 13 to be actuated during said relative movement in the X-direction between punch carrier 15 and motor 13 if the punch shank is not to perform an axial movement. In this case, therefore, second motor 12 for the movement of punch carrier 15 in the X-direction and third motor 13 would have to be operated simultaneously.

In the examples of embodiment of FIGS. 5a and 5b, linkage point 34 or punch shank holder 16 is on the other hand not jointly moved when punch carrier 15 is moved relative to motor 13 or first drive wheel 22 in the X-direction.

FIGS. 3, 5a and 5b also show an example of embodiment for a possible bearing of punch shank 8 in punch carrier 15. Punch shank 8 is thus guided so as to be movable back and forth in the Z-direction and rotatable in the C-direction in three bearings 25, which are constituted for example as sliding bearings or ball bearings.

A punch shank drive wheel 26 is arranged between the two lower bearings 25, which punch shank drive wheel is connected non-rotatably to punch shank 8. Punch shank drive wheel 26 is connected, like bearings 25, to punch carrier 15 and is stationary with respect thereto. Via punch shank drive 26, a rotational movement can be imparted to punch shank 8, which will be described further in the following.

Punch shank holder 16 is arranged between the two upper bearings 25, wherein the spacing between these two bearings 25 is selected with a size such that punch shank holder 16 can perform the described punch stroke in a portion 15a with a length of 160 mm along the Z-direction.

In the example of embodiment of the bearing in FIGS. 3, 5a and 5b, punch shank 8 penetrates respective bearing 25 centrally. In another example of embodiment in FIG. 4, a bearing with two rollers 25′ is represented as an alternative to each bearing 25, the roller axis of which rollers runs orthogonal to extension direction E of punch shank 8 and the circumferential surfaces whereof engage with the flattened sides of punch shank 8. Rollers 25′ are acted upon by a spring force and are movable relative to one another when punch shank 8 rotates between rollers 25′.

FIG. 6 shows a possible option for the drive of punch shank drive wheel 26. Punch shank drive wheel 26 is driven by a second endless belt 28, which is constituted here as a toothed belt, wherein second endless belt 28 is guided via a second drive wheel 27 and two deflection rollers 29. Second drive wheel 27 is in turn operated by fourth motor 14 and is stationary with respect thereto. One of deflection rollers 29 is also arranged stationary with respect to second drive wheel 27 and fourth motor 14. Another of deflection rollers 29 is connected to punch carrier 15 and is stationary with respect thereto.

Second endless belt 28 extends here in the clockwise direction over a first portion 28a between punch shank drive wheel 26 and second drive wheel 27, in the further course over a further portion 28b between second drive wheel 27 and deflection roller 29 stationary with respect to drive wheel 27, in the further course then over a further portion 28c between last-mentioned deflection roller 29 and a deflection roller 29 connected rotatably to punch carrier 15 and in the further course then over a portion 28d between the last-mentioned deflection roller 29 and punch shank drive wheel 26, wherein portion 28a then finally follows the latter portion again. Portions 28a, 28b and 28c run in parallel to one another.

In the case of gear unit 21 represented in FIG. 6, it is also ensured that a relative movement of punch carrier 15 relative to fourth motor 14 stationary with respect thereto and second drive wheel 27 is possible parallel to the X-direction and second endless belt 28 nonetheless remains tensioned. In addition or as an alternative to one of deflection rollers 29, a tensioning wheel (not represented) can nonetheless also be provided here, which exerts a permanent pretension on second endless belt 28.

The bearing of punch carrier 15 is represented in FIG. 7, which bearing ensures that the latter can be moved back and forth both parallel to the X-direction and also parallel to the Y-direction. The movement parallel to the X-direction is thus ensured by guided device 18, which is constituted here as sled 18, which guided device is mounted movably in guide device 17 in the X-direction. Guide device 17 is in turn mounted movably in or on a frame 19 parallel to the Y-direction.

Finally, FIG. 8 shows further examples of embodiment of a punch 10 for previously described embodiment 1, wherein punch foot 9 is constituted as a blow-off and suction nozzle 30.

According to a first variant, punch shank 8 is constituted as a hollow shaft and is connected at its first, upper end 8a to a compressed air connection 31, which comprises a supply 32 coaxial with punch shank 8 respectively extension direction E. A fluid connection between coaxial supply 32 and punch foot 9 is thus achieved via punch shank 8 constituted as a hollow shaft, as a result of which punch foot 9 can be acted upon with an underpressure (for engagement of a label 5 by suction) or with an overpressure (for blowing-off of label 5).

An alternative compressed air connection 31′ is shown in the lower section of FIG. 8, which compressed air connection is arranged between punch shank 8 and punch foot 9 and comprises a lateral supply 32′ running orthogonal to extension direction E. In this case, punch shank 8 does not necessarily have to be constituted as a hollow shaft. A fluid connection exists in this case between lateral supply 32′ and punch foot 9, so that an underpressure and an overpressure can thus also be generated in punch foot 9.

In the represented example of embodiment in FIG. 8, respective compressed air connection 31 and 31′ and associated supply 32 and 32′ are not driven along by fourth motor 14, so that the compressed air connection and the supply are not jointly rotated during a rotational movement of punch shank 8 and punch foot 9.

1. An apparatus for labelling a package, the apparatus comprising:
an advancing device for transporting the package in a transport direction,
a dispensing device for dispensing labels in a dispensing direction,
an application device for applying a dispensed label from the dispensing device on the package, and
a control device for controlling the application device,
wherein:
the application device comprises a punch, wherein the punch comprises a punch shank and a punch foot, for moving the dispensed label from at least one receiving position, where the dispensed label is picked up by the punch foot, to at least one delivery position where the dispensed label is applyable on the package by the punch foot,
the punch shank extends in an extension direction from a first shank end to a second shank end, said punch foot being connected to the second shank end of the punch shank,
the punch shank is mounted in the application device such that the punch shank is capable of movements in at least three different movement directions,
the application device comprises a plurality of motors controlled by the control device, wherein each of said motors is configured to move the punch shank in one of the at least three different movement directions,
the control device is configured such that the punch shank is simultaneously movable in the at least three of the movement directions by the plurality of motors,
the motors are mounted in the application device such that during simultaneous movement of the punch shank in the at least three directions, none of plurality of motors simultaneously moving the punch shank changes position relative to any other of the plurality of motors simultaneously moving the punch shank, and
a first of the plurality of motors brings about a translational movement of the punch shank in a first movement direction that is orthogonal to the extension direction.

2. The apparatus according to claim 1, wherein the punch shank is mounted in the application device such that the punch shank is capable of:
the translational movement in the first movement direction that is orthogonal to the extension direction,
a translational movement in a second movement direction that is orthogonal to the extension direction and to the first movement direction,
a translational movement in a third movement direction that is parallel to the extension direction, and
a rotational movement in a fourth movement direction about an axis of rotation of the punch shank, which axis of rotation extends parallel to the extension direction.

3. The apparatus according to claim 1, wherein any one or more of:
a second of the plurality of motors brings about a translational movement of the punch shank in a second movement direction that is orthogonal to the extension direction and to the first direction;
a third of the plurality of motors brings about a translational movement of the punch shank in a third movement direction parallel to the extension direction; and
a fourth of the plurality of motors brings about a rotational movement of the punch shank in a fourth movement direction about an axis of rotation which extends parallel to the extension direction.

4. The apparatus according to claim 3, wherein the control device is configured to simultaneously actuate at least the second motor, the third motor and the fourth motor.

5. The apparatus according to claim 1, wherein the dispensing direction runs parallel to the transport direction.

6. The apparatus according to claim 3, wherein the application device comprises a punch carrier in or on which the punch shank is mounted movably in the third movement direction and/or the fourth movement direction.

7. The apparatus according to claim 6, wherein the application device comprises a punch shank holder, wherein said punch shank holder is mounted movably parallel to the third movement direction in or on the punch carrier and with which the punch shank is connected immovably.

8. The apparatus according to claim 6, wherein the application device further comprises a guide device in or on which the punch carriers and/or a guided device forming a component of the punch carrier is mounted movably parallel to one movement direction selected from a group consisting of the first movement direction and the second movement direction.

9. The apparatus according to claim 8, wherein the application device further comprises a frame in or on which the guide device is mounted movably parallel to another direction selected from the group consisting of the first movement direction and the second movement direction.

10. The apparatus according to claim 9, wherein at least one of the motors is stationary relative to the guide device or the frame.

11. The apparatus according to claim 9, wherein at least the first motor is stationary relative to the frame.

12. The apparatus according to claim 3, wherein any one or more of the first motor, the second motor, the third motor, the fourth motor, and a component movable by any of said motors comprises a position sensor.

13. The apparatus according to claim 3, wherein any one or more of the first motor, the second motor, the third motor and the fourth motor is a position-controlled motor.

14. The apparatus according to claim 3, wherein any one or more of the first motor, the second motor, the third motor and the fourth motor is connected via a gear unit to a component movable by any of said motors.

15. The apparatus according to claim 14, wherein the third motor drives a first drive wheel via which a first endless belt is guided, and wherein the first endless belt is also guided via at least five deflection rollers.

16. The apparatus according to claim 15, wherein the first drive wheel and at least one of the deflection rollers is stationary relative to the third motor and/or at least four of the deflection rollers are stationary relative to the punch carrier.

17. The apparatus according to claim 15, wherein a first portion of the first endless belt runs parallel to the third movement direction, wherein the first portion is stationary with respect to the punch shank or punch shank holder and is connected thereto, and wherein the first portion extends between two of the deflection rollers, which are fastened to the punch carrier.

18. The apparatus according to claim 15, wherein at least four further portions of the first endless belt run at an angle to the third movement direction and/or at an angle to the first movement direction, and wherein the further portions do not make mutual contact.

19. The apparatus according to claim 18, wherein, of the further portions:
no portion or at least one portion or at least two portions extends/extend between the first drive wheel and one of the deflection rollers stationary relative to the first drive wheel; and/or
at least one portion or at least four portions or at least six portions extends/extend between one of the deflection rollers stationary relative to the first drive wheel and one of the deflection rollers fastened to the punch carrier; and/or
no portion or at least two portions extends/extend between two of the deflection rollers fastened to the punch carrier; and/or
no portion or at least one portion or at least two portions extends between the first drive wheel and one of the deflection rollers fastened to the punch carrier.

20. The apparatus according to claim 6, wherein the punch shank in or on the punch carrier is guided in at least one bearing, which is stationary relative to the punch carrier.

21. The apparatus according to claim 7, wherein the punch shank holder is movable relative to the punch carrier in the third movement direction by a distance in a range from 100 to 200 mm.

22. The apparatus according to claim 6, wherein a punch shank drive wheel is connected non-rotatably to the punch shank and is movable together with the punch shank in the fourth movement direction, and wherein the punch shank drive wheel is stationary relative to the punch carrier.

23. The apparatus according to claim 22, wherein the punch shank drive wheel is arranged coaxial with respect to a bearing.

24. The apparatus according to claim 22, wherein the fourth motor drives a second drive wheel via which a second endless belt is guided, and wherein the second endless belt is also guided via at least two deflection rollers and the punch shank drive wheel.

25. The apparatus according to claim 24, wherein the second drive wheel and at least one of the at least two deflection rollers are stationary relative to the fourth motor and/or at least one of the at least two deflection rollers is stationary relative to the punch carrier.

26. The apparatus according to claim 24, wherein a first portion of the second endless belt runs at an angle to the third movement direction and/or at an angle to the first movement direction.

27. The apparatus according to claim 26, wherein the first portion of the second endless belt extends between the punch shank drive wheel and the second drive wheel, and at least one other portion extends between a deflection roller stationary relative to the motor and a deflection roller stationary relative to the punch carrier, and wherein the first portion and the at least one other portion run at an angle to the third movement direction and/or at an angle to the first direction.

28. The apparatus according to claim 1, wherein the punch shank is movable relative to the fourth motor in the fourth movement direction through at least 90°.

29. The apparatus according to claim 6, wherein the punch carrier is movable relative to the third motor and/or fourth motor in the second movement direction by a distance in a range from 30 to 60 mm.

30. The apparatus according to claim 1, wherein the punch foot is a blow-off and/or suction nozzle and the punch shank and/or the punch foot is connected to a compressed air connection for applying an underpressure and/or an overpressure.

31. The apparatus according to claim 30, wherein the compressed air connection is connected to the first shank end and comprises a supply coaxial with the punch shank, wherein the punch shank is a hollow shaft such that there is a fluid connection between the coaxial supply and the punch foot via the punch shank.

32. The apparatus according to claim 30, wherein the compressed air connection is arranged between the punch shank and the punch foot and comprises a lateral supply such that there is a fluid connection between the lateral supply and the punch foot.

33. The apparatus according to claim 31, wherein the compressed air connection cannot be moved by the fourth motor.

34. A method for labelling a package using an apparatus according to claim 1, wherein:
the package is transported in a transport direction,
a label is dispensed in a dispensing direction,
the dispensed label is picked up in a receiving position by a punch foot of a punch comprising the punch foot and a punch shank connected thereto,
the punch shank with the dispensed label picked up by the punch foot is moved by a plurality of motors until the dispensed label is applied on the package by the punch foot in a delivery position
the punch shank, in order to move the dispensed label from the receiving position to the delivery position, is moved simultaneously in at least three movement directions by at least three of the motors,
the motors, which bring about the simultaneous movement of the punch shank in the at least three movement directions, do not change their position relative to one another during movement of the punch shank in the at least three movement directions, and
at least three motors are simultaneously actuated to perform the movement of the punch shank in the at least three movement directions, said at least three motors being selected from a group consisting of:
a first motor that brings about a translational movement in a first direction that is orthogonal to the extension direction,
a second motor that brings about a translational movement in a second direction that is orthogonal to the extension direction and to the first direction,
a third motor that brings about a translational movement in a third direction parallel to the extension direction, and
a fourth motor that brings about a rotational movement in a fourth direction about an axis of rotation, which extends parallel to the extension direction.
